(19) United States
(12) Patent Application Publication
(10) Pub. No.: US 2016/0031693 A1
(43) Pub. Date: Feb. 4, 2016

(54) APPARATUS AND METHOD FOR ENHANCING PRESENTATION OF A BEVERAGE

(71) Applicants: James A. Trulaske, St. Louis, MO (US); Stephen M. Schmitt, Hazelwood, MO (US)

(72) Inventors: James A. Trulaske, St. Louis, MO (US); Stephen M. Schmitt, Hazelwood, MO (US)

(21) Appl. No.: 14/814,282

(22) Filed: Jul. 30, 2015

Related U.S. Application Data
(60) Provisional application No. 62/032,500, filed on Aug. 1, 2014.

(51) Int. Cl. B67D 1/00

(52) U.S. Cl. CPC B67D 1/0015

(57) ABSTRACT

Apparatus and methods for enhancing presentation of a beverage, particularly adapted for adding a longer lasting, creamy foamed head to a beer or other malt beverage, which enhancing can be done when the beverage is served or later, and separately of dispensing the beverage. The enhancement provided by the creamy foamed head can increase aroma, and customize or change flavor and appearance, including by the addition of design and/or marketing features, to increase perceived value. As another advantage, the apparatus of the invention can be provided in advance of the dispensing of the beverage, and separately, including in a disposable, hand held container.

This application claims the benefit of U.S. Provisional Application No. 62/032,500, filed Aug. 1, 2014.

### TECHNICAL FIELD

This invention relates generally to apparatus and methods for enhancing presentation of a beverage, particularly adapted for adding a longer lasting, creamy foamed head to a beer or other malt beverage, which enhancing can be done when the beverage is served or later, and separately of dispensing the beverage. The enhancement provided by the creamy foamed head can increase aroma, and customize or change flavor and appearance, including by the addition of design and/or marketing features, to increase perceived value. As another advantage, the apparatus of the invention can be provided in advance of the dispensing of the beverage, and separately, including in a disposable, hand held container.

### BACKGROUND ART

U.S. Provisional Application No. 62/032,500, filed Aug. 1, 2014, is incorporated herein by reference in its entirety.

Competition for consumers amongst beverage makers and servers is fierce, particularly in the beer and other malt beverage segments. Brewers presently are some of the largest purchasers of consumer advertising. It has been observed, however, that when a beer is served in an open container for consumption, if the presentation is perceived as poor, that is, the beer has a head or collar (foam on upper surface of the beer) that is thin or non-existent, or which contains large gaps and bubbles, consumers can be left with a perception that the beer is poor quality and upon ordering again may select a competitor's product. This possibility may be increased when mass market beers that produce a small or poor head are served beside those marketed as craft beers, and English ales or stouts, served or presented so as to have an enhanced appearance, including particularly a thick creamy foamed head. In addition to a thick creamy head, aroma, particularly of hops and other scents, can be important to presentation, even to casual consumers, and a creamy foamed head can be useful to the release of aroma.

The above characteristics are noticeably lacking in many of the mass market beers, not because they lack quality, but because they are very light. That is, they lack the abundance of malt and hops that produce most of the flavor and aroma in beer. This is by design, so that the beers are perceived as less filling. These lighter beers are naturally carbonated, and the carbonation may be enhanced by addition of carbon dioxide, both in the original holding container, and in dispensing apparatus in restaurants and drinking establishments. Ales and other malted beverages known to produce creamy foamed heads are also carbonated, and/or may be significantly nitrogenated, which is known to particularly enhance head production, initially. However, nitrogen is also known to dissipate very quickly, meaning that a nitrogen gas produced head will be short lived.

Another limitation affecting head or collar volume is that the lighter beers are intended to be consumed very cold (below 42° F.), and a colder beer will naturally produce less head, because the carbon dioxide is not as readily released from the beer at lower temperatures. So brewers, restaurants, and drinking establishments face somewhat of a dilemma, when it is desire to serve consumers cold refreshing beverages, but at the same time provide an enticing presentation including a sizable, long lasting head of creamy foam, and accompanying aroma.

A well known method of enhancing foamed head on a draught beer is to use a restrictor tap faucet, also known as a “creamer” faucet. This typically uses a disk that has small holes through it, placed in the beer flow through the faucet at the end of a pour, so that the last of the beer is directed through the small holes, to create a creamy foam by the removal of some of the gas (carbon dioxide and/or nitrogen) from solution in the beer. This works well for draught applications. However, this is not a solution for applications lacking the proper faucet, or when it is desired to replenish a dissipated head. This is also not possible when the beer is dispensed from bottles or cans. It also does not help when it is desired to enhance the beer with a different flavor, a design on top, or the like.

Thus, what is sought is a manner of enhancing the presentation of a beverage, particularly a beer or other malt beverage, that provides one or more of the benefits, and overcomes one or more of the shortcomings and limitations, set forth above.

### SUMMARY OF THE INVENTION

What is disclosed is apparatus and methods for enhancing presentation of a beverage, particularly adapted for adding a longer lasting, creamy foamed head to a beer or other malt beverage, which enhancing can be done when the beverage is served or later, and separately of dispensing the beverage, including when poured from a bottle or can. The invention can create or maintain a creamy foamed head, increase or better release aroma, and/or can enhance the beverage with a different flavor, a design and/or marketing feature, or the like, so as to increase perceived value, and overcomes one or more of the shortcomings and limitations set forth above.

According to a preferred aspect of the invention, a method for enhancing presentation of a beverage, comprises steps of:
providing a topping dispensing vessel prepared by transferring to an interior of the vessel a liquid topping previously pressurized in a separate container to a pressure between a few psi and about 20 psi (all pressures above local atmospheric pressure) by a pressurized gas at least partially dissolved in the topping, and then pressurizing the interior of the vessel containing the topping to a pressure of at least about 25 psi by addition of a charge of a pressurized gas, the vessel having a dispensing outlet connected to the interior including a valve configured to allow controlling dispensing of the topping from the interior through at least one orifice having a sufficiently small size such that the topping will be dispensed in a creamy, densely foamed state;
dispensing the beverage from a first container separate from the vessel, in a liquid state into an upwardly open second container; and
dispensing a quantity of the topping in the creamy, densely foamed state onto the beverage in the liquid state in the upwardly open second container.

As an attendant advantage, because the topping already is already pressurized by and contains a dissolved gas, and then is subsequently further pressurized by the present process, then dispensed through a very small orifice or orifices, the topping will produce the creamy, dense foam. It has been found that the small bubbles of this dense creamy foam are strong and long lasting, release robust aroma, and provide a pleasant and smooth feel on the palate. As a non-limiting example, the desired creamy foam discharged from the orifice or orifices will have bubbles of a size that is not or barely visible without magnification, as compared to a foam, such as a beer foam resulting from dispensing from a standard container or faucet, which will have an average bubble size that is easily seen with the unaided eye. Additionally, the creamy foam will have a smooth creamy mouth feel, as compared to a coarser foam resulting from dispensing from a standard container or faucet.

According to another preferred aspect of the invention, to achieve desired visual appeal, aroma, and mouth feel, the step of pressurizing the interior of the vessel, that pressure is between about 30 psi and about 150 psi by the addition of the charge of the pressurized gas, which can be provided via any suitable pressurized gas source, including but not limited to, a commercially available pressurized gas cartridge, or connected tank, or compressor. This has been found to be advantageous as it further improves the quality of the foam, by providing sufficient pressure to dissolve more gas into the topping to thus provide more bubbles when dispensed. The greater pressure has also been found to speed dispensing of the topping. As another important advantage, it has been observed during testing that a foamed topping dispensed according to the invention will typically last substantially longer than foamed toppings created by the dispensing of the beverage itself, notably, when the beverage is a beer or other malt beverage.

According to another preferred aspect of the invention, the step of dispensing the beverage from a first container comprises depositing a layer of the beverage in a foamed state having a first density, onto the beverage in the liquid state in the second container, and wherein the quantity of the topping in the creamy densely foamed state has a second density substantially less than the first density of the existing layer of foam. As an attendant advantage, even though both are foamed, the less dense or lighter topping will remain on the heavier foamed layer of the first beverage and not quickly disperse therein, so as to provide a desired taste, aesthetic effect, or the like. As non-limiting examples, the topping and foamed beverage may be of different colors and/or flavors.

As a representative example here wherein both the beverage and topping comprises the same type of beer, it has been found that the creamy densely foamed head of the topping can have a lower density, as a non-limiting example, a density of about one-half or so of the naturally occurring density of the beer foam. This lighter, yet dense head has been found to be long lasting, yet very smooth on the palate and has an enhanced aroma.

According to another preferred aspect, the topping is a beer previously pressurized to a pressure of greater than atmospheric pressure and less than about 15 psi by carbon dioxide gas at a ratio of about between about 2 and about 4 volumes of the carbon dioxide gas to 1 volume of the beer. Attendant advantages here include that a commercially available beer can be used, and will have its familiar and sought after taste. The beverage can also be a beer, including the same beer or a different one, e.g., a heavier beer, so that the combination of the will provide desired characteristics, such as taste, aroma, and/or a lighter smoother sensation on the palate. Additionally, either or both the beverage and the topping can comprise any malt beverage, such as any of the familiar commercially available fruit flavored malt beverages widely available from AB-Inbev. As an attendant advantage, it has been found that beer toppings or “head” dispensed according to the invention can last at least 3 or 4 minutes, and in some instances, substantially longer, whereas foam toppings or “heads” of some commercially available beers have been observed to last less than 2 minutes. This represents a significant improvement for presentation of lighter beers that don't naturally produce a robust head, such as lagers and the like when served cold in the American tradition which naturally releases less of the carbon dioxide dissolved in the beer.

According to another preferred aspect of the invention, the step of dispensing the quantity of the topping in the densely foamed state onto the beverage while in the upwardly open second container, comprises using the topping to form a design on an upper surface of the beverage. As a non-limiting example, the design can be a geometrical design or shape, and can be in a contrasting color. This can be as the only topping, or as an additional topping placed on a foamed topping such as a head on a beer or other malt beverage. As an alternative, or in addition, the topping can be deposited as one or more letters or numbers. In either instance, the topping can form a well known trademark, e.g., a crown, stylized letter “B” or the like.

As non-limiting options, the first container from which the beverage is dispensed, can comprise a draught keg, a can, bottle, or pitcher, etc. The beverage can be a malt beverage, such as a beer, and the topping can also be a malt beverage such as a beer, and the beverage and the topping can comprise the same malt beverage or beer, of different ones; e.g., the beverage can comprise a heavier or more dense beer, a different color beer, etc., and the topping a lighter or less dense beer, or a fruit flavored malt beverage, such as but not limited to, those available from AB-Inbev under the well known tradenames Lime-A-Rita, Straw-ber-ita, and associated products.

According to another preferred aspect of the invention, apparatus for enhancing presentation of a beverage comprises a topping dispensing vessel containing a liquid topping previously pressurized in a separate container greater than atmospheric but less than about 20 psi, for instance, but not limited to, by a carbonaceous gas at least partially dissolved in the topping. The topping is pressurized in the vessel to a noticeably and effectively greater pressure for achieving the desired effects set forth above. As a non-limiting example, pressurizing the vessel to a pressure of between about 25 psi and about 150 psi by a charge of a pressurized gas has been found to work well. The vessel has a dispensing outlet including a valve configured to allow manually controlling dispensing of the topping from the vessel through at least one orifice having a sufficiently small size such that the topping will be dispensed in a densely foamed state. Again, because of the presence of the already partially dissolved gas and existing pressure, and then the additional pressurization, the dispensed topping has been found to have a very fine, long lasting creamy foamed state, which provides enhanced release of the aroma of the topping, e.g., beer or other malt beverage, for better presentation. As a visual comparative example, a standard American pale lager such as commercially available under the Budweiser trademark, can be used as a topping prepared in the above-described manner, either for a beverage of the same beer, or another beer or ale, and has been found to provide a creamy head substantially similar to that created by dispensing a draught stout, such as commercially available under the Guinness trademark and known for having a very fine creamy head. According to various configurations of the apparatus of the invention, the orifice can be located in the interior of the vessel so that the topping is drawn therethrough by the opening of the valve, it can be incorporated into the valve or external to the vessel such as in a dispensing passage, e.g., through a tubular tip. In this latter regard, the tip whether including the orifice or not, can be configured as a removable disposable article, if desired. The vessel can be configured as a hand held device, and can be disposable, e.g., similarly to widely commercially available whipped topping dispensers, if desired.

As a preferred configuration, the at least one orifice has a size of less than about 0.05 inch, as a non-limiting example, 0.02 inch, and can include several such small orifices, e.g. as a non-limiting example, 2 to 7 orifices. A particularly preferred configuration utilizes between about 2 and about 7 orifices of about 0.02 inch each, downstream of a hand operated valve. When used with a pale lager beer as a topping, pressurized at a pressure of at least about 30 psi, this has been found to be capable of producing a thick head of creamy densely foamed beer, generally having the appearance of a fine cream (bubbles barely visible without magnification) such as would be produced by dispensing of a stout such as a Guinness, and which will remain in place for at least 4 minutes.

According to another preferred aspect of the invention, the vessel include a second valve configured for attachment of a gas charging device to the vessel for selectably pressurizing the vessel to the higher pressure, which charging device can be a cartridge, external tank or reservoir, compressor, or the like. A preferred pressurizing gas is carbon dioxide, but can be a mixture of carbon dioxide and nitrogen, as a non-limiting example.

As an alternative application for the apparatus of the invention, the dispensing outlet can be configured for injecting the topping, e.g., a malt beverage such as a beer, in the creamy densely foamed state, into or onto meat during or after cooking and prior to serving, if desired. This has been particularly advantageous for imparting a beer flavor and aroma to sausages such as bratwurst, and hamburgers.

### BRIEF DESCRIPTION OF THE DRAWINGS

FIG. 1 is a sectional view through a representative prior art container, which is a common pint glass, showing associated prior art apparatus for dispensing a beverage into the container;

FIG. 2 shows the container of FIG. 1, holding a beverage, and various pressurized topping dispensing vessel for dispensing a topping from a pressurized state in a creamy densely foamed state onto the beverage according to the invention;

FIG. 3 is a side view of aspects of a representative pressurized topping dispensing vessel of the invention, illustrating various containers of topping in an initial pressurized liquid state that can be dispensed into the vessel, pressurized gas cartridges for pressurizing the vessel when containing the topping, and optional additives for the topping;

FIG. 4 is a simplified schematic diagram showing one configuration of apparatus of the invention, including the pressurized topping dispensing vessel, a dispensing valve, and dispensing orifice;

FIG. 5 is a simplified schematic diagram showing another configuration of apparatus of the invention, including the pressurized vessel, a dispensing valve, and dispensing orifice;

FIG. 6 is a simplified schematic diagram showing still another configuration of apparatus of the invention, including the pressurized vessel, a dispensing valve, and dispensing orifice;

FIG. 7 shows apparatus of the invention injecting a densely foamed topping into a meat product according to the invention;

FIG. 8 shows apparatus of the invention dispensing a foamed topping according to the invention into a cup; and

FIG. 9 shows apparatus of the invention dispensing a foamed topping onto a beverage which is a beer.

### DETAILED DESCRIPTION OF THE INVENTION

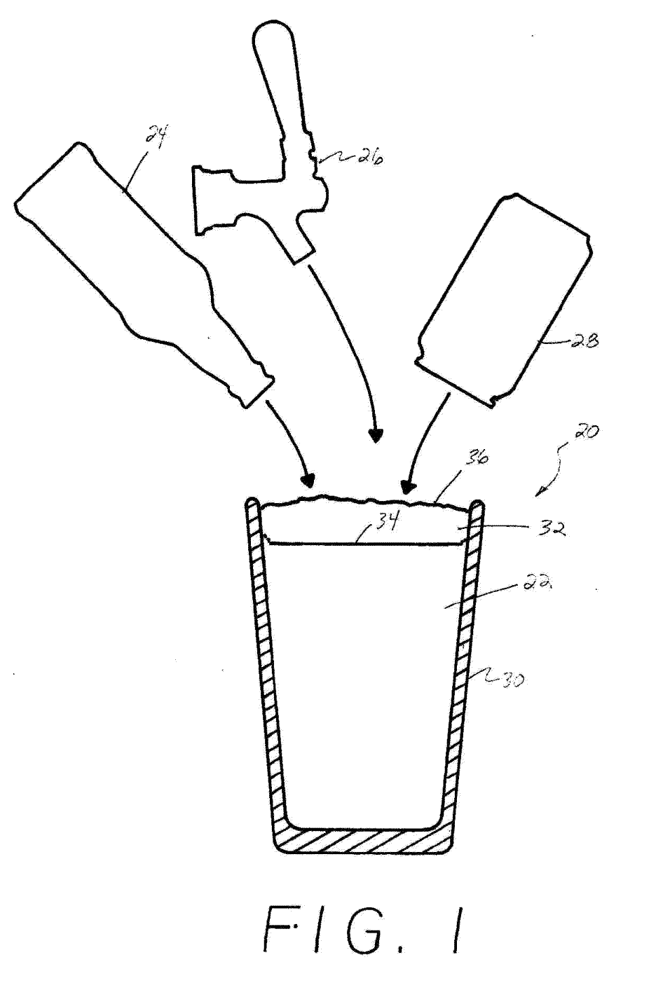

Referring now to the drawings, FIG. 1, shows a representative commercially available prior art beverage container 20, and associated optional dispensers for dispensing a beverage 22 into container 20, including but not limited to, a bottle 24, a faucet 26, and a can 28, as illustrated by arrows. Beverage 22 is representative of a wide variety of beverages that can be used with the invention, including, but not limited to, a beer, ale, stout, a malt beverage, such as any of the familiar commercially available fruit flavored malt beverages widely available from AB-Inbev, and the like, including a combination of different beverages. Container 20 is a conventional widely commercially available pint glass container, although the invention is not limited to that container only and as other non-limiting examples, the container can comprise a bowl style, tulip style, or other desired shape, each of which can be made of a suitable material, such as, but not limited to, glass or plastics, and each of which can be generally defined as including a sidewall 30 having a generally upstanding inner surface bounding an upwardly open cavity 32 for receiving and holding a liquid beverage, so as to have an upwardly facing upper surface 34. These and any of the other containers with which the invention is used can be round, other curved shape, or polygonal in sectional shape when viewed from above. Here, it should be understood that the present invention can be additionally utilized with a wide variety of beverage containers, including additionally, but not limited to, cups, mugs, goblets, tumblers, wine glasses, pitchers, and the like.

It can be observed also that for the purposes of the invention, upper surface 34 can comprise liquid surface, and/or a foam surface 36, such as is commonly created on a liquid surface when a gaseous beverage is dispensed, e.g., a beer, stout, or ale. In this regard, it is common for a container to have a line across sidewall 30, which denoted as a “pour line”, to which the liquid beverage will desirably be poured when the filling the container, the portion of cavity 32 above the pour line typically being denoted as a “collar zone” and which will desirably contain the beverage in a foamed state to some extent when the container is considered filled with the beverage. As a non-limiting example, the collar zone can commonly have a vertical extent of about an inch or less, and a typical collar or “head” of foamed beverage will have a vertical extent of a fraction of the collar zone, for example, ⅛ to ½ inch. In this latter regard, as discussed above, it is typically desired for the foamed collar to have a rich, creamy consistency, preferably fully covering the liquid beverage below, for best presentation. Common concerns in regard to collar include poor initial quality, such as thinness and poor coverage which can be due to dissipation of the foamed collar to an extent that it includes voids and unattractive large bubbles resulting from coalescence of smaller bubbles into much larger bubbles than would be normally considered foam. Generally, the smaller the bubbles comprising the collar, and the more robust it is, the more satisfactory it will be considered to be, and the higher the quality of the beverage.

As a non-limiting example, for a beverage 22 that is a beer, stout, or ale, the container from which it is dispensed will typically be previously pressurized to a pressure of greater than atmospheric pressure and less than about 15 psi by carbon dioxide gas at a ratio of about between about 2 and about 4 volumes of the carbon dioxide gas to 1 volume of the beverage.

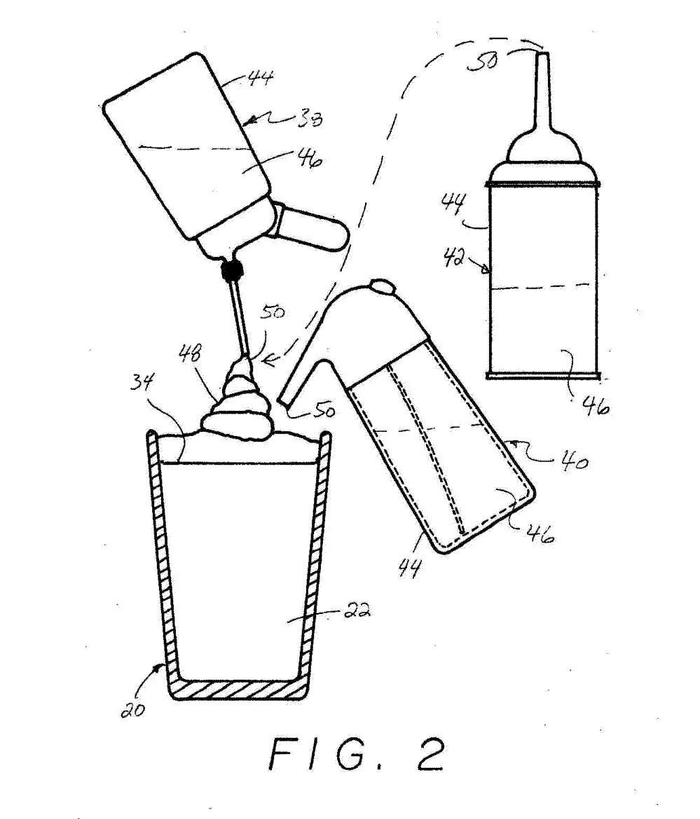

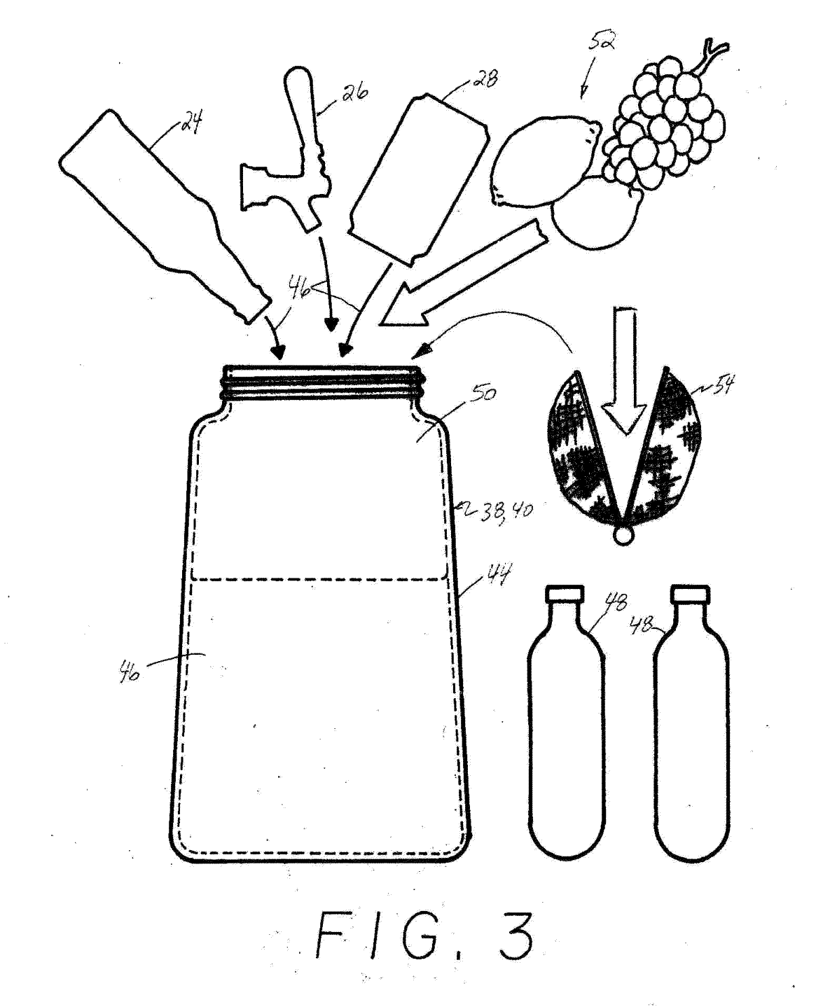

Referring to FIG. 2, container 20 containing beverage 22 is shown in association with three optional apparatus 38, 40, and 42 for enhancing presentation of a beverage according to the invention. Referring also to FIG. 3, each of apparatus 38, 40, and 42 generally comprises a topping dispensing vessel 44 configured for pressurization, and containing a liquid topping 46 previously pressurized in a separate container to a pressure greater than atmospheric but less than about 20 psi, by a gas, for instance, but not limited to, by a carbonaceous gas at least partially dissolved in the liquid topping. The topping is additionally pressurized in vessel 44 to a noticeably and effectively greater pressure for achieving the desired effects of the invention, namely dispensing of the topping a densely foamed state 48 onto upper surface 34 of a beverage 22 contained in a container 20 (FIG. 2). As a non-limiting example, pressurizing vessel 44 to a pressure of between about 25 psi and about 150 psi by a charge of a pressurized gas has been found to be suitable according to the invention. Suitable gas charging apparatus can include well known, commercially available carbon dioxide cartridges 48 (FIG. 3), nitrogen cartridges, or the like, pieced when installed on the vessel to vent pressurized gas into the interior of the vessel, in the well known manner. To achieve a desired level of pressurization, multiple cartridges 48 can be used. Suitable commercially available apparatus 38 can comprise re-usable pressurized whipped cream dispensers widely commercially available under the tradenames iSi; Whip-it!; Mosa, and the like. Suitable commercially available apparatus 40 can comprise seltzer bottles available under the tradenames iSi; Whip-it!; Soda Siphon; SodaStream, and the like. Suitable commercially available apparatus 42 can include pre-charged disposable aerosol filled dispensers for whipped cream available under the tradename Reddi-whip; Land O Lakes; and the like (adapted to contain the topping of the invention).

In the instance of apparatus 38 and 40, the liquid topping 46 can be conveniently received, e.g., poured from a suitable source of the pressurized liquid, such as, but not limited to, any of bottle 24, faucet 26, or can 28 into the interior 50, by any personnel, such as a bartender, helper, food or beverage preparer, or the like. This task will be conducted quickly, to retain a suitable amount of the dissolved gas in the topping 46, for purposes of the invention. In the case of apparatus, 42, it is most likely to be filled with topping 46 still containing the dissolved gases, by an appropriate filling apparatus in a factory or bottling facility. In addition to liquid topping 46, additives, such as, but not limited to, flavoring agents such as fruit 52, juices, spices, flavenoids, etc., can be added. Flavoring agents in a solid state, e.g., fruit 52 can be contained in a suitable permeable container 54, such as a basket or the like, which can be placed in interior 50 with topping 46, so as to be infused into the topping as it is dispensed.

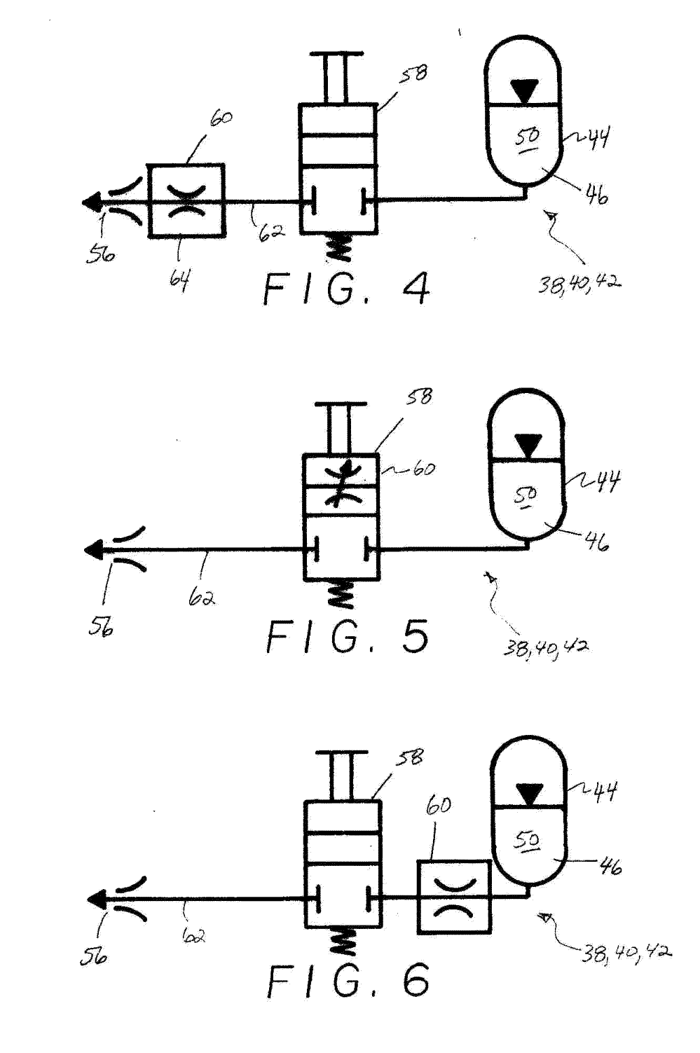

Referring also to FIGS. 4, 5, and 6, each apparatus 38, 40, and 42 has a dispensing outlet 56 including a valve 58 configured to allow controlling dispensing of topping 46 from interior 50 the vessel through at least one orifice 60 having a sufficiently small size such that topping 46 will be dispensed in a densely foamed state, similar in consistence to a whipped cream or a high quality beer head. Valve 58 can be manually operated, automatic, or operable in another suitable manner, as desired for a particular application. Orifice 60 can be an existing orifice of the commercially available apparatus 38, 40, or 42, but preferably comprises an additional, smaller orifice or orifices, such as through a plate installed in a flow path 62 between vessel 44 and valve 58, or between valve 58 and outlet 56. In the former location, the orifice or orifices 60 can be within interior 50, or external thereto, and in the latter location the orifice or orifices 60 can be located in a removable member or assembly for cleaning, or disposal. For instance, a tube or fitting of flow path 62 can be a removable or disposable item, incorporating an integral nozzle plate 64, or can be provided with a removable nozzle plate 64, as desired. In a commercially available configuration, vessel 44 is a pressurizable bottle or can of steel or similar material, and valve 58 is incorporated into a lid or other closure that threads or otherwise fastens to the vessel, in the well known manner.

As a preferred configuration, orifice or orifices 60 has/have a size of less than about 0.05 inch each, as a non-limiting example, 0.02 inch. A suitable number of orifices 60, as a non-limiting example, can comprise 2 to 7 orifices. As an exemplary configuration, it has been found that between about 2 and about 7 orifices of about 0.02 inch each, downstream of a hand operated valve, when used with beer as a topping, pressurized at a pressure of at least about 30 psi, will be capable of producing a thick head of creamy densely foamed beer, but which has an actual density of about one-half that of the beer when normally dispensed from a can, bottle or faucet. As a result, because of the presence of the already partially dissolved gas in the topping from its original pressurization, and then the additional pressurization, the dispensed topping has been found to have a very fine, long lasting creamy foamed state, which provides enhanced release of the aroma of the topping, e.g., beer or other malt beverage, for better presentation.

As noted above, the preferred topping 46 is a beer, ale, stout, malt beverage, etc., previously pressurized to a pressure of greater than atmospheric pressure and less than about 15 psi by carbon dioxide gas at a ratio of about between about 2 and about 4 volumes of the carbon dioxide gas to 1 volume of the beer. As a result, a commercially available beer or malt beverage product, e.g., Lime-A-Rita, Straw-ber-ita, etc., can be used, and will have its familiar and sought after taste. The beverage onto which the topping is placed can also be a beer, malt beverage, or the like, the same or different from the topping, e.g., a heavier beer or malt beverage, so that the combination will provide desired characteristics, such as taste, aroma, and/or a lighter smoother sensation on the palate. In experiments it has been found that a beer toppings or “head” dispensed according to the invention can last at least 3 or 4 minutes, and in some instances, substantially longer, which represents a significant improvement for presentation of lighter beers that don't naturally produce a robust head, such as lagers and the like when served cold in the American tradition which naturally releases less of the carbon dioxide dissolved in the beer.

As another option, the step of dispensing the quantity of the topping in the densely foamed state onto the beverage while in the upwardly open second container, can comprise using the topping to form a design on an upper surface of the beverage. As a non-limiting example, the design can be a geometrical design or shape, and can be in a contrasting color. This can be as the only topping, or as an additional topping placed on a foamed topping such as a head on a beer or other malt beverage. As an alternative, or in addition, the topping can be deposited as one or more letters or numbers. In either instance, the topping can form a well known trademark, e.g., a crown, stylized letter “B” or the like.

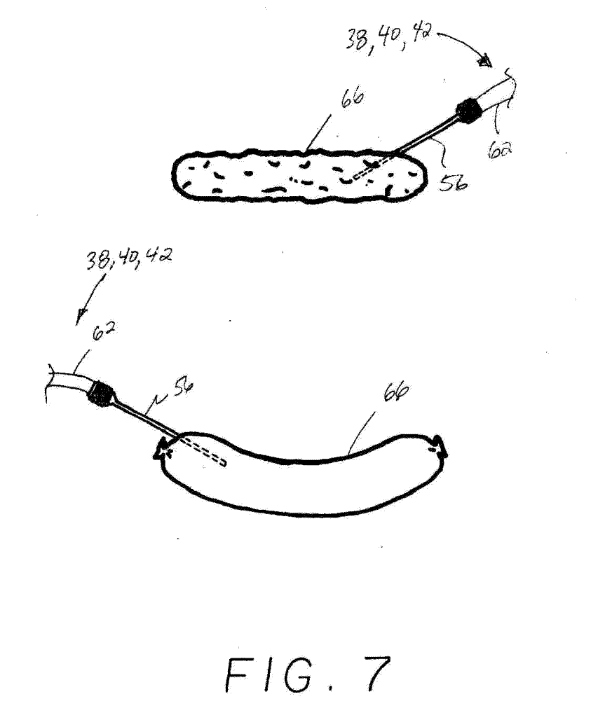

As still another variation of the invention, FIG. 7 shows apparatus 38, 40, 42 of the invention in use in an alternative application, dispensing outlet 56 being configured for injecting the topping, e.g., a malt beverage such as a beer, in the creamy densely foamed state, into or onto a food product 66 such as a meat item during or after cooking and prior to serving, if desired. In this embodiment, dispensing outlet 56 is configured as a narrow injector device capable of penetrating the food item, and can be attached to apparatus 38, 40, 42 as an extension of flow path 62, which can be a tube, hose or the like or incorporated as part of a lid of the vessel of the apparatus. This has been particularly advantageous for imparting a beer flavor and aroma to sausages such as bratwurst, hamburgers, and the like.

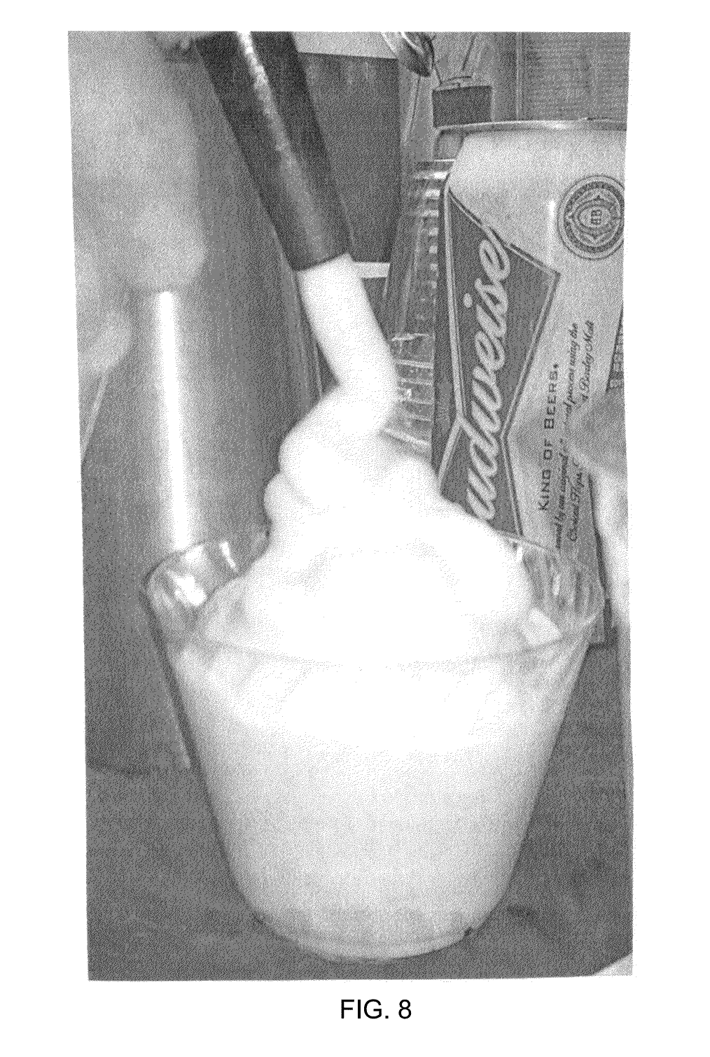

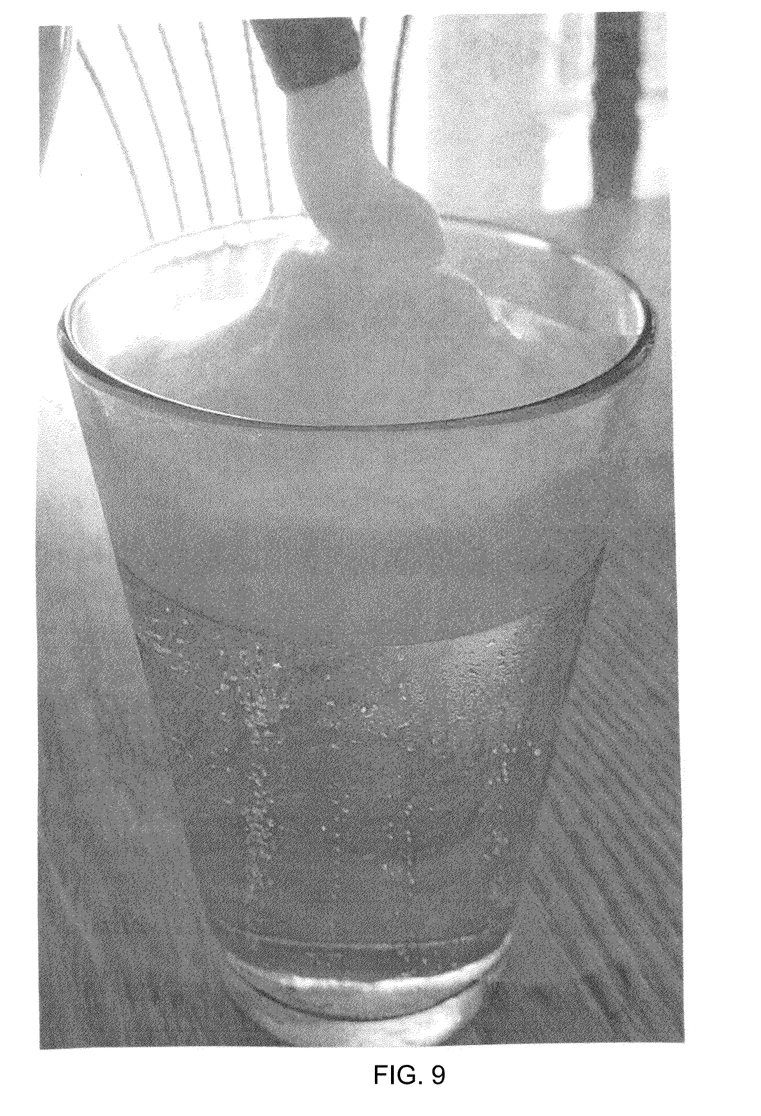

In FIGS. 8 and 9 it can be observed that a topping according to the invention, which is a beer, can be dispensed into a container such as a cup (FIG. 8) or the like, or onto a beverage such as a beer (FIG. 9), and will have a consistency of a thick cream, like a whipped cream, that will retain the dispensed shape, here a helical cone, for a short time, and will gradually settle into more of a level head having a highly creamy mouth feel and aroma.

In light of all the foregoing, it should thus be apparent to those skilled in the art that there has been shown and described an APPARATUS AND METHOD FOR ENHANCING PRESENTATION OF A BEVERAGE. However, it should also be apparent that, within the principles and scope of the invention, many changes are possible and contemplated, including in the details, materials, and arrangements of parts which have been described and illustrated to explain the nature of the invention. Thus, while the foregoing description and discussion addresses certain preferred embodiments or elements of the invention, it should further be understood that concepts of the invention, as based upon the foregoing description and discussion, may be readily incorporated into or employed in other embodiments and constructions without departing from the scope of the invention. Accordingly, the following claims are intended to protect the invention broadly as well as in the specific form shown, and all changes, modifications, variations, and other uses and applications which do not depart from the spirit and scope of the invention are deemed to be covered by the invention, which is limited only by the claims which follow.

What is claimed is:

1. A method for enhancing presentation of a beverage, comprising steps of:
providing a topping dispensing vessel prepared by transferring to an interior of the vessel a liquid topping previously pressurized in a separate container to a pressure between a few psi greater than atmospheric pressure and about 20 psi greater than atmospheric pressure by a pressurized gas at least partially dissolved in the topping, and then pressurizing the interior of the vessel containing the topping to a pressure of at least about 25 psi above atmospheric pressure by addition of a charge of a pressurized gas, the vessel having a dispensing outlet connected to the interior including a valve configured to allow manually controlling dispensing of the topping from the interior through at least one orifice having a sufficiently small size such that the topping will be dispensed in a creamy densely foamed state;
dispensing the beverage from a first container separate from the vessel, in a liquid state into an upwardly open second container; and
dispensing a quantity of the topping in the creamy densely foamed state onto the beverage in the liquid state in the upwardly open second container.

2. The method of claim 1, wherein the step of pressurizing the interior of the vessel pressurizes it to a pressure of between about 30 psi and about 150 psi above atmospheric pressure by the addition of the charge of the pressurized gas.

3. The method of claim 1, wherein the topping comprises a beer.

4. The method of claim 3, wherein the beverage comprises a beer.

5. The method of claim 1, wherein the topping and the beverage comprise different beers.

6. The method of claim 1, wherein the step of dispensing the beverage from a first container comprises depositing a layer of the beverage in a foamed state having a first density, onto the beverage in the liquid state, separate from the vessel, and wherein the quantity of the topping in the creamy densely foamed state has a second density substantially less than the first density.

7. The method of claim 1, wherein the topping comprises a malt beverage.

8. The method of claim 1, wherein the at least one orifice is incorporated into the valve.

9. The method of claim 1, wherein the at least one orifice is disposed in the interior of the vessel.

10. The method of claim 1, wherein the at least one orifice has a size of less than about 0.05 inch.

11. The method of claim 1, wherein the topping is a beer previously pressurized to a pressure of greater than atmospheric pressure and less than about 15 psi above atmospheric pressure by carbon dioxide gas at a ratio of about between about 2 and about 4 volumes of the carbon dioxide gas to 1 volume of the beer.

12. The method of claim 1, wherein the step of dispensing the quantity of the topping in the creamy densely foamed state onto the beverage while in the upwardly open second container, comprises using the topping to form a design on an upper surface of the beverage.

13. The method of claim 1, wherein the step of dispensing the quantity of the topping in the creamy densely foamed state onto the beverage while in the upwardly open second container, comprises using the topping to form at least one letter or number on an upper surface of the beverage.

14. A method of enhancing presentation of a beer, comprising steps of:
dispensing from a first source, a first quantity of beer pressurized to a pressure above atmospheric and less than about 20 psi thereabove, into an upwardly open container at atmospheric pressure, so as to reside in the open container in a liquid state and have an upwardly facing upper surface; and
providing a second source separate from the first source, comprising a vessel holding a second quantity of beer pressurized by a gas at least partially dissolved therein at a pressure of between about 25 psi and about 150 psi, the vessel having a valve openable to dispense a flow of the second quantity of beer through at least one orifice having an opening size sufficiently small that the flow will be dispensed in a creamy densely foamed state;
dispensing the flow of the second quantity of beer from the vessel in the creamy densely foamed state, onto the upper surface of the first quantity of beer residing in the liquid state in the container.

15. The method of claim 14, comprising a further step wherein the dispensed second quantity of beer remains in the creamy densely foamed state on the upper surface of the first quantity of beer for at least about 3 minutes.

16. The method of claim 14, wherein the step of dispensing from a first source, a first quantity of beer, comprises depositing a small amount of the first quantity of beer in a foamed state having a first density, onto the beer residing in the liquid state in the container, and wherein the second quantity of beer in the creamy densely foamed state is deposited on the first quantity of beer in the foamed state.

17. Apparatus for enhancing presentation of a beverage, comprising:
a topping dispensing vessel containing a liquid topping previously pressurized in a separate container to a pressure less than about 20 psi by a carbonaceous gas at least partially dissolved in the topping, pressurized in the vessel at a pressure of between about 25 psi and about 150 psi by a charge of a pressurized gas, the vessel having a dispensing outlet including a valve configured to allow manually controlling dispensing of the topping through at least one orifice having a sufficiently small size such that the topping will be dispensed in a creamy densely foamed state.

18. Apparatus of claim 17, wherein the at least one orifice is incorporated into the valve.

19. Apparatus of claim 17, wherein the at least one orifice is disposed in an interior of the vessel.

20. Apparatus of claim 17, wherein the vessel include a second valve configured for attachment of a gas charging device to the vessel for selectably pressurizing the vessel to the pressure of between about 25 psi and about 150 psi with the gas.
